(19) United States
(12) Patent Application Publication
(10) Pub. No.: US 2005/0201476 A1
(43) Pub. Date: Sep. 15, 2005

(54) Method and apparatus for allocating subcarriers in a broadband wireless communication system using multiple carriers

(75) Inventors: Jeong-Heon Kim, Anyang-si (KR); Jae-Ho Jeon, Seongnam-si (KR); Soon-Young Yoon, Seoul (KR); Seung-Joo Maeng, Seongnam-si (KR); In-Seok Hwang, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/077,855

(22) Filed: Mar. 11, 2005

(30) Foreign Application Priority Data
Mar. 12, 2004 (KR) 2004-17100

(51) Int. Cl. H04K 1/10

(52) U.S. Cl. 375/260

(57) ABSTRACT

A method and apparatus for efficiently allocating subcarriers for data and/or a control signal requiring frequency diversity within the same symbol and for data or a control signal which needs to be transmitted in a frequency band with successive subcarriers, so as to transmit the signals simultaneously, satisfying the different requirements of frequency diversity and successive subcarrier allocation. Therefore, signal interference is reduced for a data signal having a frequency diversity gain and requiring a high data rate or a signal interfered by other signals.

### PRIORITY

This application claims priority under 35 U.S.C. § 119 to an application entitled “Method and Apparatus for Allocating Subcarriers in a Broadband Wireless Communication System Using Multiple Carriers” filed in the Korean Intellectual Property Office on Mar. 12, 2004 and assigned Serial No. 2004-17100, the contents of which are incorporated herein by reference.

### BACKGROUND OF THE INVENTION

1. Field of the Invention

The present invention relates generally to a method of allocating communication resources in a broadband wireless communication system, and in particular, to a method and apparatus for allocating subcarriers in a broadband wireless communication system using multiple carriers.

2. Description of the Related Art

The first MCM (Multi-Carrier Modulation) systems appeared in the late 1950's for high frequency radio communication in military applications. OFDM (Orthogonal Frequency Division Multiplexing), which is a special case of MCM with overlapping orthogonal subcarriers, was initially developed in the 1970's. In OFDM, a serial symbol sequence is converted to parallel symbol sequences and modulated to mutually orthogonal subcarriers prior to transmission. Due to difficulty in orthogonal modulation between multiple carriers, OFDM has limitations in actual applications to systems.

However, in 1971, Weinstein, et. al. proposed an OFDM scheme that applies DFT (Discrete Fourier Transform) to parallel data transmission as an efficient modulation/demodulation process, which became a driving force for the development of OFDM. Also, the introduction of a guard interval further mitigates the adverse effects of multi-path propagation and delay spread on systems. Although hardware complexity was an obstacle to widespread use of OFDM, recent advances in digital signal processing technology including FFT (Fast Fourier Transform) and IFFT (Inverse Fast Fourier Transform) have enabled OFDM implementation.

OFDM can widely be exploited for digital data communications such as DAB (Digital Audio Broadcasting), digital TV broadcasting, WLAN (Wireless Local Area Network), and W-ATM (Wireless Asynchronous Transfer Mode). OFDM also shows high frequency use efficiency, reduces effects of ISI (Inter-Symbol Interference) by use of guard intervals, and is robust against multi-path fading. Therefore, OFDM achieves optimum transmission efficiency for high-speed data transmission.

OFDM-based multiple access techniques are largely divided into OFDMA (Orthogonal Frequency Division Multiple Access) and FH (Frequency Hopping)-OFDM. FH-OFDM is a combination of FH and OFDM. OFDMA is a scheme of transmitting each OFDM symbol across a plurality of subcarriers, the subcarriers forming one subchannel. Applications of OFDMA to a broadband wireless communication system are set forth in the IEEE 802.16a and IEEE 802.16e standards. Such an OFDMA system adopts a 2048-point FFT, for example. It divides 1702 tones into 166 pilot tones and 1536 data tones. The 1536 data tones are further divided into 32 subchannels for allocation to users, each subchannel including 48 data tones. Both OFDMA and FH-OFDM commonly seek to achieve frequency diversity gain by distributing data tones across the total frequency band.

In some cases, however, a gain other than a frequency diversity gain is achieved by allocating successive subcarriers in a predetermined frequency band for predetermined data or control signals. For example, a system using a frequency-selective AMC (Adaptive Modulation and Coding) scheme chooses a user at a good channel state for each frequency band and allocates the entire frequency band to the user, thereby increasing the throughput of the system.

As to a ranging channel between a base station and a mobile station in an IEEE 802.16 system, the timing of a transmission signal is not synchronized. Thus, interference from other signals needs to be reduced. To that end, subcarriers used for the ranging channel are preferably successive. If the ranging channel does not fully occupy a given frequency band, subcarriers must be allocated in the manner that yields a frequency diversity gain for data or a control signal transmitted in the remaining part of the frequency band.

### SUMMARY OF THE INVENTION

An object of the present invention is to substantially solve at least the above problems and/or disadvantages and to provide at least the advantages below. Accordingly, an object of the present invention is to provide a method and apparatus for allocating subcarriers to increase a frequency diversity gain for a predetermined transmission signal in a multi-cell environment in a broadband wireless communication system using multiple carriers.

Another object of the present invention is to provide a method and apparatus for allocating successive subcarriers to a predetermined transmission signal in a multi-cell environment in order to reduce interference between subchannels and increase a data rate in a broadband wireless communication system using multiple carriers.

A further object of the present invention is to provide a method and apparatus for efficiently allocating subcarriers, taking into account a signal requiring frequency diversity and a signal requiring successive subcarriers in a multi-cell environment in a broadband wireless communication system using multiple carriers.

The above objects are achieved by providing a method and apparatus for allocating subcarriers in an OFDMA communication system.

According to one aspect of the present invention, in a method of allocating subcarriers in a wireless communication system where a mobile station communicates with a base station on at least one subchannel including a plurality of subcarriers, a first parameter and a second parameter are set. The first parameter determines frequency diversity according to the type of signal transmitted between the mobile station and the base station and the second parameter determines the number of successive subcarriers to be allocated. Subcarriers of a total frequency band are divided into a plurality of subcarrier groups each having at least one successive subcarrier according to the first parameter. The logical positions of the subcarriers of the total frequency band are allocated using subchannel indexes and the second parameter.

According to another aspect of the present invention, in an apparatus for allocating subcarriers in a wireless communication system where a mobile station communicates with a base station on at least one subchannel including a plurality of subcarriers, a parameter setter sets a first parameter and a second parameter, the first parameter determining frequency diversity according to the type of signal transmitted between the mobile station and the base station and the second parameter determining the number of successive subcarriers to be allocated. A group decider divides subcarriers of a total frequency band into a plurality of subcarrier groups each having at least one successive subcarrier according to the first parameter. A subcarrier allocator allocates the logical positions of the subcarriers of the total frequency band using subchannel indexes and the second parameter.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a transmitter in an OFDMA communication system to which the present invention is applied;

FIG. 2 illustrates grouping of total subcarriers in a subcarrier allocation method in the broadband wireless communication system according to the present invention;

FIG. 3 is a flowchart illustrating the subcarrier allocation method in the broadband wireless communication system according to the present invention;

FIG. 4 illustrates an example of subcarrier allocation according to the subcarrier allocation method illustrated in FIG. 3; and

FIG. 5 is a block diagram of a subcarrier allocating apparatus in the broadband wireless communication system according to the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

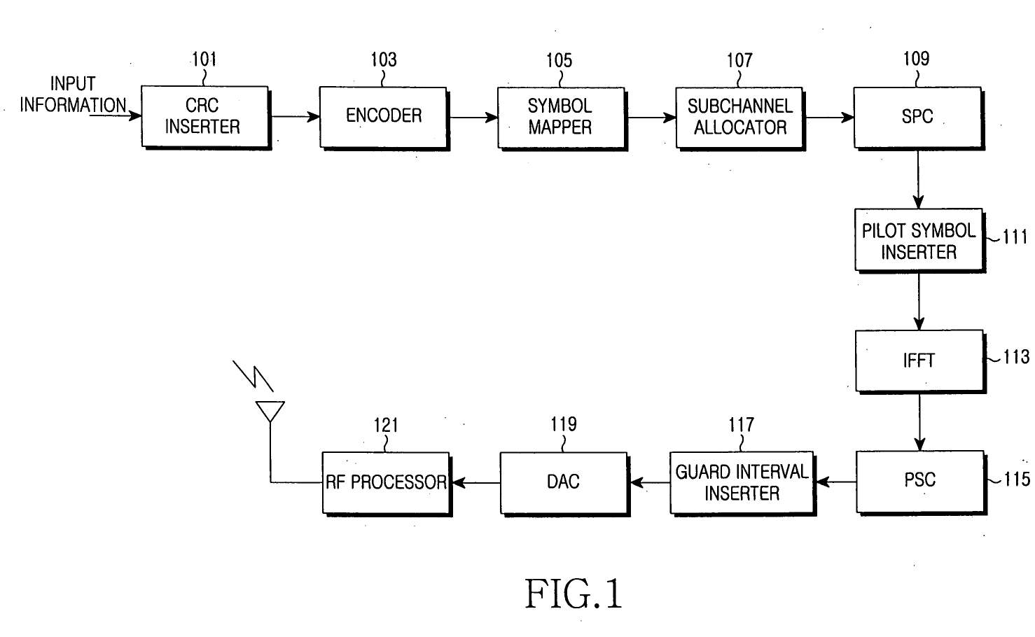

FIG. 1 is a block diagram of a transmitter in an OFDMA communication system to which the present invention is applied. Referring to FIG. 1, the transmitter includes a CRC (Cyclic Redundancy Check) inserter 101 for generating CRC bits by which transmission errors are checked, an encoder 103 for encoding data bits, a symbol mapper 105 for carrying out symbol modulation in a predetermined modulation scheme, and a subchannel allocator 107 for selectively applying subcarrier allocation for frequency diversity or successive subcarrier allocation, or allocating subchannels in the manner that satisfies the two requirements according to a subcarrier allocation method of the present invention, which will be described later.

The transmitter further includes a serial-to-parallel converter (SPC) 109 for converting serial modulated symbols to parallel modulated symbols, a pilot symbol inserter 111, an IFFT 113 for IFFT-processing the parallel modulated signals of the subchannels, a parallel-to-serial converter (PSC) 115 for converting the parallel modulated signals to a serial symbol sequence, a guard interval inserter 117 for inserting a guard interval into the serial symbol sequence, a digital-to-analog converter (DAC) 119, and an RF (Radio Frequency) processor 121.

In operation, upon generation of user data bits and control data bits (hereinafter, collectively referred to as information data bits) to be transmitted, the CRC inserter 101 inserts CRC bits into the information data bits and the encoder 103 encodes the output of the CRC inserter 101 in a predetermined coding method. For example, the coding method can be turbo coding, or convolutional coding with a predetermined code rate.

The symbol mapper 105 modulates the coded bits to symbols in the predetermined modulation scheme, such as QPSK (Quadrature Phase Shift Keying) or 16 QAM (Quadrature Amplitude Modulation). The subchannel allocator 107 allocates a subchannel and subcarriers to the modulated symbols.

The subchannel allocation is performed using a subcarrier allocation method that takes into account both subcarrier allocation for frequency diversity and successive subcarrier allocation according to the present invention, as described later in detail. The SPC 109 converts the serial modulated symbols to parallel modulated signals, to which the subchannel and its corresponding frequency band have been allocated. The pilot inserter 111 inserts pilot symbols into the parallel modulated symbols.

The IFFT 113 performs an N-point IFFT on the output signal of the pilot symbol inserter 111. The PSC 115 converts the IFFT signals to a serial signal. The guard interval inserter 117 inserts a predetermined guard interval into the serial signal. The guard interval is used to eliminate interference between the previous OFDM symbol transmitted in the previous OFDM symbol time and the current OFDM symbol transmitted in the current OFDM symbol time in transmission of an OFDM symbol sequence in the OFDMA communication system.

The DAC 119 converts the output of the guard interval inserter 117 to an analog signal. The RF processor 121, including a filter and a front end unit, processes the analog signal to an RF signal transmittable over the air and transmits the RF signal to a radio network via a transmit (Tx) antenna.

Subcarrier allocation in the subchannel allocator 107, with the aim to efficiently allocate subcarriers to data and/or a control signal requiring successive subcarriers and to data and/or a control signal requiring frequency diversity gain, will be described in detail according to an embodiment of the present invention.

Before describing the subcarrier allocation method, the channel structure of the OFDMA communication system to which the embodiment of the present invention is applied will first be briefly described.

The OFDMA communication system transmits parallel transmission data over a plurality of mutually orthogonal subcarriers. The subcarriers may include data subcarriers for delivering data and pilot subcarriers for channel estimation. One subchannel, including a plurality of subcarriers, is a basic unit for transmitting data and/or a control signal.

Regarding basic parameters used herein, N is defined as the number of total available subcarriers per symbol and M is defined as the number of subcarriers per subchannel.

According to the present invention, M is a parameter used to determine a frequency diversity gain in transmitting a frequency diversity-required signal such as an already synchronized signal receiving less effects of interference from other signals, a CQI (Channel Quality Indicator), and an ACK/NACK (Acknowledgement/Negative Acknowledgement) signal. M also indicates the number of subcarrier groups into which the total subcarriers are grouped according to the present invention. The subcarrier grouping will be described later. Therefore, M is a factor that determines how the subcarriers of one subchannel are distributed over the total frequency band. That is, the subcarriers of the subchannel are distributed to M positions in the total frequency band.

In the case where a higher data rate is required, or in the case where successive subcarriers are required, for example, for a data signal or a ranging channel signal that interferes with other signals, a basic parameter determining the number of successive subcarriers is defined as L. L is one the divisors of N/M such that N/M is divided by L, the remainder is zero. For transmission of a signal requiring high frequency diversity, M is set to a high value. On the other hand, L is set to a high value for transmission of a signal requiring allocation of a larger number of successive subcarriers.

Once M and L are determined, a basic subcarrier allocation pattern is determined. Q has the following relationship with respect to M and N. M and L must be determined that Q can be expressed basically as a prime or a prime power, as set forth in Equation (1):

$$Q = \frac{N}{M \times L} \qquad ( 1 )$$

Because the basic subcarrier allocation pattern is based on a Reed-Solomon sequence in the present invention, the parameter Q is limited to a prime or a prime number. Yet, Q can have any other numerical form depending on the basic subcarrier allocation pattern, without being limited to a prime or a prime power. The Reed-Solomon sequence is defined over a Galois field with Q elements, GF(Q). If a primitive element of GF(Q) is denoted by a, then, the Reed-Solomon sequence P₀ for the basic subcarrier allocation pattern is computed by Equation (2):

$$\begin{matrix}{P}_{0} = \{ a , {a}^{2} , {a}^{3} , … , {a}^{Q - 2} , {a}^{Q - 1} \} \\ ( {a}^{m} \neq 1 for m < Q - 1 , {a}^{Q - 1} = 1 )\end{matrix} \qquad ( 2 )$$

where m is a subcarrier index ranging from 1 to Q-2.

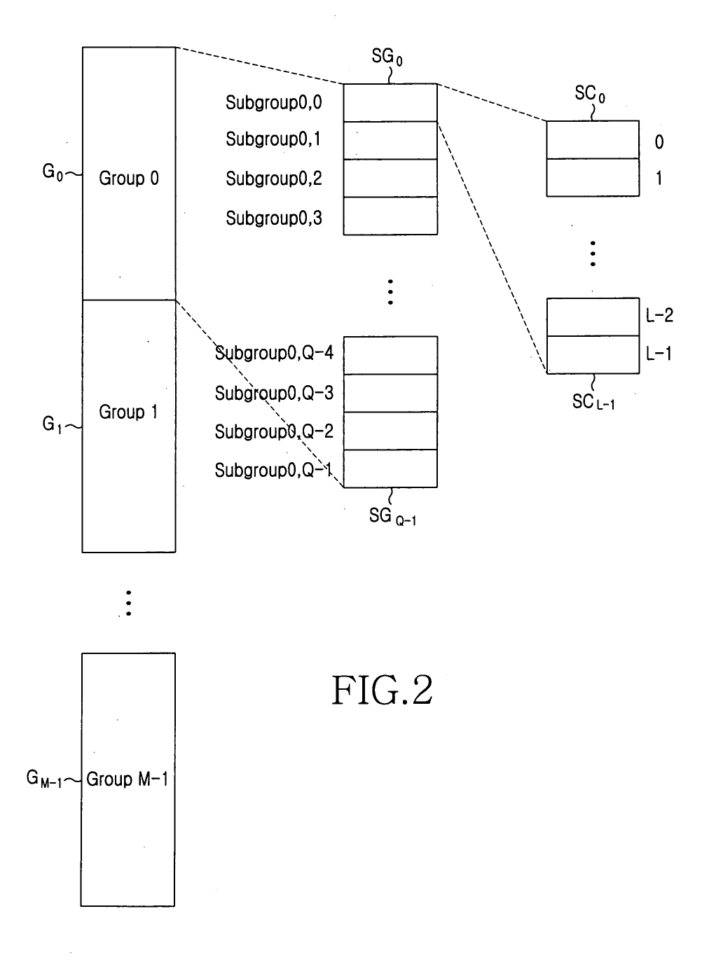

FIG. 2 illustrates grouping of total subcarriers according to the subcarrier allocation method in the broadband wireless communication system according to the present invention. Referring to FIG. 2, total N subcarriers are divided into M subcarrier groups G₀ to G_{M-1} and each subcarrier group is further divided into Q subgroups SG₀ to SG_{Q-1} each having L subcarriers SC₀ to SC_{L-1}. The total number of subchannels formed with the subcarriers is QxL and the number of subcarriers per subchannel is M.

Table 1 below lists the basic parameters required for subcarrier allocation according to the present invention.

TABLE 1

| Basic | |
|---|---|
| parameters | Meaning |
| N | Total number of subcarriers for delivering one symbol |
| M | 1. Significant factor determining frequency diversity |
| | 2. Number of subcarrier groups for delivering one symbol |
| | 3. Number of subcarriers per subchannel |
| L | 1. Significant factor determining number of successive |
| | subcarriers |
| | 2. Number of subcarriers per subcarrier subgroup |
| Q | 1. Significant factor determining basic subcarrier allocation |
| | pattern |
| | 2. Number of subcarrier subgroups per subcarrier group |

Hereinbelow, a description will be made of an algorithm of determining the indexes of subcarriers grouped in the manner illustrated in FIG. 2. That is, the following Equation (3) is an example of a subcarrier allocation formula for determining the index of an m^{th} subcarrier in an s^{th} subchannel according to the present invention.

$$Alloc ( s , m ) = \{ \begin{matrix}( N / M ) m + L \times [ {s}^{′} + {P}_{0 , c} ( m ) ] + {s}^{″} , & 0 < c < Q \\ ( N / M ) m + L \cdot {s}^{′} + {s}^{″} & c = 0\end{matrix} \} \qquad ( 3 )$$

where Alloc(s,m) denotes the subcarrier index, s is the subchannel index being an integer (0≦s≦QxL-1), m is a subcarrier index in one subchannel being an integer

$$( 0 \leq m \leq M - 1 ) , {s}^{′} = ⌊ \frac{s}{L} ⌋$$

(└ ┘ is an operation of computing a maximum integer less than or equal to s/L), and s″=s mod L (mod represents modulation).

In Equation (3), the first term of the right side (N/M)m selects one of the M groups G₀ to G_{M-1} according to the subcarrier index m, and the second term Lx[s′+P_{0,c}(m)] selects one of the Q subgroups SG₀ to SG_{Q-1}. The operation result of [ ] ranges from 0 to Q-1 and P_{0,c}(m) is an m^{th} value of a sequence obtained by cyclically shifting P₀ c times to the left. The variable c corresponds to the number or ID (Identifier) of a base station. The last term s″ selects one of the L subcarriers SC₀ to SC_{L-1} in the selected subgroup.

Equation (3) is so designed that the subcarriers of the total frequency band are divided into M groups (M is a parameter determining frequency diversity) and the logical positions of the subcarriers are determined using L (a parameter determining the number of successive subcarriers) and s (a subchannel index). Therefore, Equation (3) can be modified invarious ways using the above-described basic parameters.

In accordance with the present invention, the total frequency band is divided into M subcarrier groups according to the number of subcarriers per subchannel, taking into account frequency diversity, and each of the M subcarrier groups is divided into a plurality of subgroups. Considering that the concept of the subgroup is introduced to describe successive subcarrier allocation, once L is selected from the divisors of N/M, successive subcarriers can be allocated from each of the M groups. In other words, without defining the subgroups as illustrated in FIG. 2, both subcarrier allocation for frequency diversity and successive subcarrier allocation can be carried out in the M groups.

The operation within [ ] in Equation (3) is done over GF(Q). If Q=p^{q}, s is expressed as a p-decimal number (p is a prime number) prior to the operation. The number of successive subcarrier groups allocated from each subcarrier group is determined by L and can be up to Lx p^{q}.

Meanwhile, QxL subchannels are produced by Equation (2), each including M subcarriers. In real implementation, however, a basic allocation unit can be a group of subcarriers in a time-frequency area, instead of a subcarrier in Equation (3). In this case, each of Q subgroups is formed on a basis of a group of at least two subcarriers allocated on the time and frequency axes. By replacing a subcarrier by a time-frequency group of subcarriers in Equation (3), a subchannel comprised of time-frequency groups of subcarriers can be allocated.

If successive subcarriers are to be allocated or subcarriers are to be allocated on a time-frequency subcarrier group basis, for example L successive subcarriers 0 to L-1, L to 2L-1, . . . , and (Q-1)L to QL-1 are allocated or M time-frequency subcarrier groups are allocated, the allocation is carried out based on Equation (3). On the other hand, for data and/or a control signal requiring frequency diversity, M subcarriers or M time-frequency subcarrier groups with an average distance of QxL on the frequency axis are allocated by Equation (3).

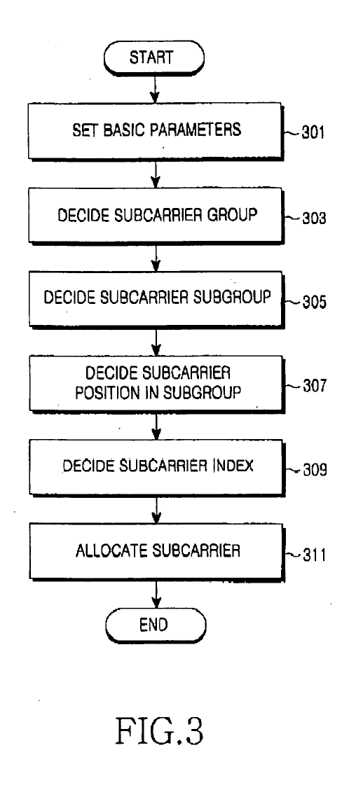

Now, with reference to FIG. 3, a description will be made of the subcarrier allocation method based on the grouping illustrated in FIG. 2 using the basic parameters of Table 1 and Equation (3) in the subchannel allocator 107 of FIG. 1.

Referring to FIG. 3, the subchannel allocator 107 preliminarily sets the basic parameters illustrated in Table 1 for subcarrier allocation in step 301. Thus, a frequency band with N subcarriers is divided into M subcarrier groups, and each subcarrier group is divided into Q subcarrier subgroups to each of which the frequency band of L subcarriers is allocated. When high frequency diversity is required according to the type of data and a control signal, M is set to a high value. If the number of successive subcarriers is to be increased, L is set to a high value. M and L are empirically set.

In step 303, the subchannel allocator 107 determines a subcarrier group by substituting the value of a subcarrier index m in a subchannel, ranging from 0 to M-1, into the first term of Equation (3), (N/M)m. The subchannel allocator 107 then determines a subcarrier subgroup to which the subcarrier belongs in step 305 by calculating s′ being the quotient of dividing a subchannel index s, cyclically shifting the base sequence of Equation (2) P₀ c times (where c is a base station number) to one direction (e.g. to the left), extracting an m^{th} value of the resulting sequence, and computing the second term [ ] using s′ and the m^{th} value. If c is 0, the m^{th} value is 0.

In step 307, the subchannel allocator 107 determines the position of the subcarrier in the subgroup by computing s mod L in the third term of Equation (3). The subchannel allocator 107 determines the index of the subcarrier by summing the values obtained in steps 303 to 307 in step 309 and allocates a subcarrier frequency band according to the subcarrier index in step 311. While the subcarrier allocation method illustrated in FIG. 3 is performed on a subcarrier basis, it is also applicable to subcarrier allocation on a time-frequency subcarrier group basis.

For better understanding of the present invention, the subcarrier allocation method will be described using an example.

The following description is made in the context of subcarrier allocation to a ranging channel, a CQI channel, and an ACK channel over three successive symbols on the uplink of an IEEE 802.16 system. The number N of subcarriers available to one symbol is 864, and a basic allocation unit is a time-frequency 3×2 subcarrier group. Here, M=4, L=4 and Q=432/(4×4)=27.

In this case, Equation (3) is expressed as shown in Equation (4):

$$Alloc ( s , m ) = \{ \begin{matrix}108 m + 4 \times [ {s}^{′} + {P}_{1 , c} ( m ) ] + {s}^{″} , & 0 < c < 27 \\ 108 m + 4 \cdot {s}^{′} + {s}^{″} & c = 0\end{matrix} \} \qquad ( 4 )$$

where Alloc(s,m) denotes the index of an m^{th} time-frequency subcarrier group in an s^{th} subchannel.

In the example, m ranges from 0 to 3 and s ranges from 0 to 107. P_{1,c}(m) is an m^{th} value of a sequence obtained by cyclically shifting P₁ c times in a direction (e.g. to the left). P₁={001, 212, 112, 102, 101, 222, 110, 011, 210, 021, 211, 200, 020, 002, 121, 221, 201, 202, 111, 220, 022, 120, 012, 122, 100, 010}. The elements of P₁ are ones of GF(27), expressed in groups of three, i.e. as ternary numbers. c=ID_{cell} mod 27 (ID_{cell} is a base station number).

The operation of [ ] in Equation (3) is addition over GF(27) and the addition of the subchannel index s and the elements of P₁ is modulo 3 addition at each ternary digit. For example, (112)₃+(111)₃=(220)₃ over GF(27) and thus (220)₃=24. After forming subchannels according to Equation (3), subchannels #0 to #11 are allocated to the ranging channel so that 12 successive time-frequency subcarrier groups are from each of four subcarrier groups. Subchannels other than subchannels #0 to #11 are available to the CQI or the ACK channel having less signal interference.

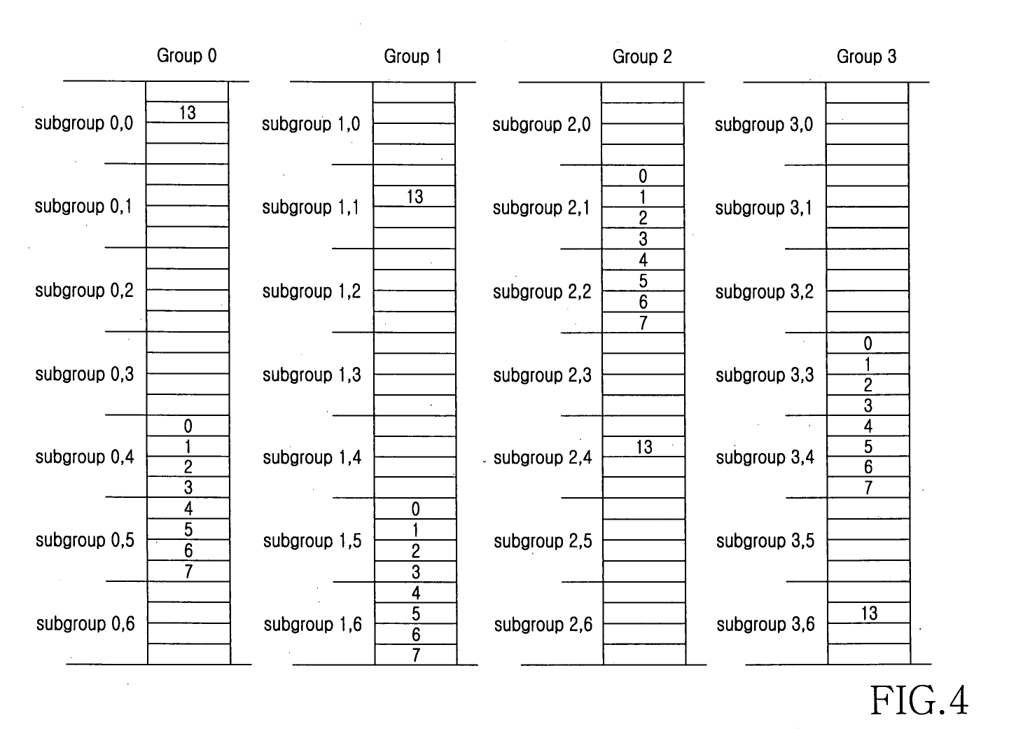

FIG. 4 illustrates an example of subcarrier allocation carried out in the method of FIG. 3. Subchannels and subcarriers are allocated herein under the conditions that N=112, M=4, L=4, Q=7, and a base station number is 3. Therefore, subcarriers are allocated to each subchannel by Equation 5:

$$Alloc ( s , m ) = \{ \begin{matrix}28 m + 4 \times [ {s}^{′} + {P}_{1 , c} ( m ) ] + {s}^{″} , & 0 < c < 7 \\ 28 m + 4 \cdot {s}^{′} + {s}^{″} & c = 0\end{matrix} \} \qquad ( 5 )$$

where m ranges from 0 to 3 and s ranges from 0 to 27. P_{1,c}(m) is an m^{th} value of a sequence obtained by cyclically shifting P₁ c times to the left. P₁={3, 2, 6, 4, 5, 1}. The elements of P₁ are ones of GF(7). c=ID_{cell} mod 7 (ID_{cell} is the base station number). In FIG. 4, each box or rectangle represents a subcarrier and the number inside the rectangle represents the subchannel index s. As noted from FIG. 4, as subchannels #0 to #7 are allocated, eight successive subcarriers are selected from each of the four groups. These subchannels can be applied to data and/or a control signal requiring successive subcarriers like the ranging channel.

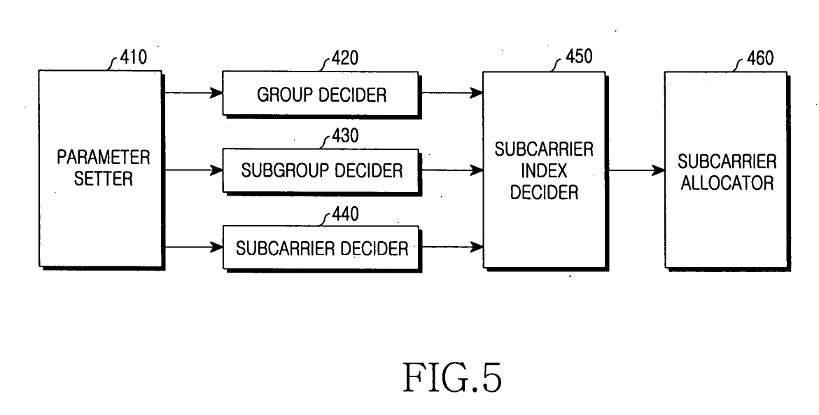

FIG. 5 is a block diagram of a subcarrier allocating apparatus in the broadband wireless communication system according to the present invention. The subcarrier allocating apparatus operates according to the subcarrier allocation method of the present invention.

Referring to FIG. 5, a parameter setter 410 divides total subcarriers for delivering at least one symbol into a plurality of subcarrier groups, further divides each subcarrier group into a plurality of subcarrier subgroups, and sets a plurality of basic parameters for allocating a plurality of subcarriers to each subgroup. A group decider 420 determines the subcarrier group to which a subcarrier belongs. A subgroup decider 430 determines the subgroup to which the subcarrier belongs in the determined group. A subcarrier decider 440 determines the location of the subcarrier in the determined subgroup. A subcarrier index decider 450 determines the index of the subcarrier according to the determined location. A subcarrier allocator 460 allocates the frequency band of the subcarrier according to the subcarrier index.

The subgroup decider 430 and the subcarrier decider 440 can be integrated into the group decider 420 and the subcarrier index decider 450 can be integrated into the subcarrier allocator 460.

In the above configuration, the parameter setter 410 increases M when high frequency diversity is required according to the type of data and a control signal to be transmitted and increases L when the number of successive subcarriers needs to be increased. M and L are empirically appropriate values. The number of subcarriers per subchannel is the number of the entire subcarrier groups, M. In the case of successive subcarrier allocation, the number of successive subcarriers from each of the M groups depends on L, and up to Lxp^{q} successive subcarriers can be allocated from each of the M groups. p^{q} is determined by Q=p^{q} in an operation where the subchannel index s is expressed as a p-decimal number and p is a prime number. The subcarrier index decider 450 and the subcarrier allocator 460 determine the indexes of subcarriers in the total frequency band using the basic parameters and Equation (3), and allocate subcarriers according to the subcarrier indexes.

As described above, the present invention provides a subcarrier allocation method for performing subcarrier allocation for frequency diversity or successive subcarrier allocation, or for allocating subcarriers, satisfying the two requirements by one subcarrier allocation in an OFDMA communication system. Thus, interference between cells is reduced.

While the invention has been shown and described with reference to certain preferred embodiments thereof, it will be understood by those skilled in the art that various changes in form and details may be made therein without departing from the spirit and scope of the invention as defined by the appended claims.

1. A method of allocating subcarriers in a wireless communication system where a mobile station communicates with a base station on at least one subchannel including a plurality of subcarriers, comprising the steps of:
setting a first parameter and a second parameter, the first parameter determining frequency diversity and the second parameter determining the number of successive subcarriers to be allocated according to the type of a transmission signal between the mobile station and the base station;
dividing subcarriers of a total frequency band into a plurality of subcarrier groups each having at least one successive subcarrier according to the first parameter; and
allocating the logical positions of the subcarriers of the total frequency band using subchannel indexes and the second parameter.

2. The method of claim 1, wherein the parameter setting step comprises setting the first parameter to a high value if interference between the transmission signal and other signals on adjacent subcarriers is small.

3. The method of claim 2, wherein the parameter setting step comprises setting the second parameter to a high value if interference between the transmission signal and other signals on adjacent subcarriers is large.

4. The method of claim 2, wherein the parameter setting step comprises setting the second parameter to a high value in proportion to a required data rate for the transmission signal.

5. The method of claim 1, wherein the allocating step comprises allocating the logical positions of the subcarriers according to
$$Alloc ( s , m ) = \{ \begin{matrix}( N / M ) m + L \times [ {s}^{′} + {P}_{0 , c} ( m ) ] + {s}^{″} , & 0 < c < Q \\ ( N / M ) m + L \cdot {s}^{′} + {s}^{″} & c = 0\end{matrix} \}$$
where M is the first parameter, L is the second parameter, s is a subchannel index being an integer (0≦s≦Qx_{L-1}), Q is a parameter determining a subcarrier allocation pattern, m is a subcarrier index in one subchannel being an integer
$$( 0 \leq m \leq M - 1 ) , {s}^{′} = ⌊ \frac{s}{L} ⌋$$
(└ ┘ is an operation of computing a maximum integer less than or equal to s/L), and s″=s mod L (mod represents modulation).

6. The method of claim 5, wherein the parameter Q is determined by
$$Q = \frac{N}{M \times L}$$
where N is the number of subcarriers of the total frequency band.

7. The method of claim 6, wherein the allocating step comprises allocating up to Lxp^{q} successive subcarriers from each of the subcarrier groups, if Q=p^{q} in terms of p decimal numbers and p is a prime number, the number of successive subcarriers to be allocated from each of the subcarrier groups being determined according to L.

8. The method of claim 1, wherein the allocating step comprises allocating the logical positions of the subcarriers on a time-frequency subcarrier group basis.

9. The method of claim 1, wherein the allocating step comprises computing the logical locations of the subcarriers using a Reed-Solomon sequence.

10. The method of claim 1, wherein the parameter setting step comprises setting the second parameter to one of the divisors of the value of dividing the total number of the subcarriers by the number of the subcarrier groups.

11. An apparatus for allocating subcarriers in a wireless communication system where a mobile station communicates with a base station on at least one subchannel including a plurality of subcarriers, comprising:
a parameter setter for setting a first parameter and a second parameter, the first parameter determining frequency diversity according to the type of and the second parameter determining the number of successive subcarriers to be allocated according to the type of a transmission signal between the mobile station and the base station;
a group decider for dividing subcarriers of a total frequency band into a plurality of subcarrier groups each having at least one successive subcarrier according to the first parameter; and
a subcarrier allocator for allocating the logical positions of the subcarriers of the total frequency band using subchannel indexes and the second parameter.

12. The apparatus of claim 11, wherein the parameter setter sets the first parameter to a high value if interference between the transmission signal and other signals on adjacent subcarriers is small.

13. The apparatus of claim 12, wherein the parameter setter sets the second parameter to a high value if interference between the transmission signal and other signals on adjacent subcarriers is large.

14. The apparatus of claim 12, wherein the parameter setter sets the second parameter to a high value in proportion to a required data rate for the transmission signal.

15. The apparatus of claim 11, wherein the subcarrier allocator allocates the logical positions of the subcarriers according to
$$Alloc ( s , m ) = \{ \begin{matrix}( N / M ) m + L \times [ {s}^{′} + {P}_{0 , c} ( m ) ] + {s}^{″} , & 0 < c < Q \\ ( N / M ) m + L \cdot {s}^{′} + {s}^{″} & c = 0\end{matrix} \}$$
where M is the first parameter, L is the second parameter, s is a subchannel index being an integer (0≦s≦Qx_{L-1}), Q is a parameter determining a subcarrier allocation pattern, m is a subcarrier index in one subchannel being an integer
$$( 0 \leq m \leq M - 1 ) , {s}^{′} = ⌊ \frac{s}{L} ⌋$$
is an operation of computing a maximum integer less than or equal to s/L), and s″=s mod L (mod represents modulation).

16. The apparatus of claim 15, wherein the parameter setter determines the parameter Q according to
$$Q = \frac{N}{M \times L}$$
where N is the number of subcarriers of the total frequency band.

17. The apparatus of claim 16, wherein the subcarrier allocator allocates up to Lxp^{q} successive subcarriers from each of the subcarrier groups, if Q=p^{q} in terms of p decimal numbers and p is a prime number, the number of successive subcarriers to be allocated from each of the subcarrier groups being determined according to L.

18. The apparatus of claim 11, wherein the subcarrier allocator allocates the logical positions of the subcarriers on a time-frequency subcarrier group basis.

19. The apparatus of claim 11, wherein the subcarrier allocator computes the logical locations of the subcarriers using a Reed-Solomon sequence.

20. The apparatus of claim 11, wherein the parameter setter sets the second parameter to one of the divisors of the value of dividing the total number of the subcarriers by the number of the subcarrier groups.
